(19) United States
(12) Patent Application Publication
(10) Pub. No.: US 2005/0280181 A1
(43) Pub. Date: Dec. 22, 2005

(54) Apparatus for and method of forming indentations in a closure strip

(76) Inventors: Robert R. Turvey, Sanford, MI (US); Christine A.L. Howell, Clinton Township, MI (US)

Correspondence Address: S.C. JOHNSON & SON, INC., 1525 HOWE STREET, RACINE, WI, 53403-2236, US

(21) Appl. No.: 10/871,426

(22) Filed: Jun. 18, 2004

(51) Int. Cl. B29C 59/02

(52) U.S. Cl. 264/284; 425/385

(57) ABSTRACT

A crimp press for forming indentations in a pouch closure strip includes a guide track adapted to receive interlocked closure strips attached to a web and carrying a slider. The crimp press includes a reciprocating die having an adjustable stroke located over the guide track. The interlocked closure strips, web, and slider are fed through the guide track a predetermined distance and then indexed while the reciprocating die impacts the interlocked closure strips thereby imparting the desired indentations onto the closure strips. The process may then be repeated. A second crimp press for forming periodically spaced indentations in a pouch closure strip includes a pair of opposing die wheels between which the closure strip is passed. The die wheels include raised die surfaces and recessed slider cutouts and rotate in synchronized motion to form the indentations in the closure strips. The slider cutouts allow a slider on the closure strips to pass between the die wheels without being damaged.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to pouch production apparatus and methods, and more particularly to an apparatus for and method of forming indentations in a closure strip.

2. Description of the Background of the Invention

A reclosable thermoplastic pouch includes opposing bag walls forming a mouth, interlocking closure strips carried by the bag walls along the mouth, and a slider. The pouch may be repeatedly opened and closed by sliding the slider back and forth along the closure strip. It is often desirable to have some sort of tactile or audible sensation during the opening or closing actions. This may be accomplished by forming indentations or other variations along the closure strips that engage the slider.

Branson U.S. Pat. No. 4,787,755 discloses a method of forming a reclosable pouch having closure strips. The closure strips are sealed to a bag wall web at each predefined individual bag length using an ultrasonic sealing head.

Herrington, Jr. et al. U.S. Pat. No. 5,131,121 discloses a method of and apparatus for forming end stops for a pair of closure strips carrying a slider. The opposed closure strips and slider are fed past a pair of ultrasonic reciprocating anvils. The anvils converge against opposite sides of the closure strips and ultrasonically deform the closure strips therebetween to form an end stop.

Herrington, Jr. U.S. Pat. No. 5,152,613 discloses a method of and apparatus for forming a reclosable pouch including interlocking closure strips carried by opposite bag walls at a mouth of the pouch. A pair of opposing gear racks are pressed against opposite sides of the closure strips after the strips have been heat welded to the bag walls in order to stretch the strips and bag walls to counteract post welding shrinking. The gear racks impart an embossed appearance to the bag walls.

Provan et al. U.S. Pat. Nos. 6,622,353 and 6,470,551 disclose a method of and apparatus for forming a continuous closure strip having sliders attached thereto and seal portions and cutout portions formed at predefined spacings therealong. The closure strip is advanced a bag width and temporarily stopped while impact presses form the seal portions and cutout portions at separate work stations.

White et al. U.S. Pat. No. 6,686,005 discloses a method of and apparatus for forming end terminations at opposite ends of a closure strip. A pair of molds are brought together around an end of the closure strips and molten material is fed into the molds to form the end termination on the closure strip.

### SUMMARY OF THE INVENTION

According to one aspect of the present invention, a device for crimping a closure strip includes a funnel adapted to receive the closure strip, a partially enclosed track extending from the inlet funnel and adapted to receive the closure strip therein, a crimping die located adjacent to the track and shiftable toward the track, and an actuator connected to the die. The actuator urges the die toward the track for crimping the closure strip.

According to another aspect of the present invention, an apparatus for crimping a pair of interlocked closure strips carrying a slider includes an inlet funnel and a guide track extending from the inlet funnel, a crimping die located adjacent to the track, and an actuator connected to the die. The interlocked closure strips and the slider are slidably carried within the inlet funnel and the guide track, and the actuator shifts the die between a first position spaced away from the track and a second position spaced nearer to the track to crimp the interlocked closure strips.

According to another aspect of the present invention, a method of forming an indentation in a closure strip carrying a slider and attached to a web includes the step of advancing the closure strip and slider a predefined length along a guide track adjacent to an impact die press. The closure strip is stopped adjacent to the die press. The stopped closure strip is impacted with the die press within the guide track.

According to another aspect of the invention, a device for forming indentations in an elongate closure strip includes a first rotatable die wheel having an outer periphery and a second rotatable die wheel having an outer periphery, wherein the first die wheel is spaced opposite the second die wheel a distance sufficient to allow the closure strip to pass between opposing portions of the peripheries thereof. A raised die surface is disposed on the outer periphery of at least one of the die wheels and a drive mechanism is provided for driving the die wheels in synchronized rotation such that the die surface is adapted to contact and form the indentations in the closure strip as the die wheels are rotated.

### BRIEF DESCRIPTION OF THE DRAWINGS

FIG. 1 is an isometric view of a pouch with a slider thereon that may be produced according to the present invention;

FIG. 2 is an elevational view of the pouch of FIG. 1 wherein the pouch is closed;

FIG. 3A is an enlarged, fragmentary, sectional view taken generally along the lines 3A-3A of FIG. 2;

FIG. 3B is an enlarged sectional view similar to that of FIG. 3A but showing another embodiment of indentations;

FIG. 4 is an isometric view of a further pouch that may be produced according to the present invention;

FIG. 4A is an enlarged sectional view taken generally along the lines 4A-4A of FIG. 4;

FIG. 4B is an enlarged, fragmentary, sectional view taken generally along the lines 4B-4B of FIG. 4;

FIG. 5 is an isometric view of a roll of closure material that may be produced according to the present invention;

FIG. 6 is an isometric view of a crimp press according to the present invention;

FIG. 7 is a side elevational view of the crimp press of FIG. 6;

FIG. 8 is a partial sectional view taken generally along the lines 8-8 of FIG. 7;

FIG. 9 is an isometric view of the track plate of the crimp press of FIG. 6;

FIGS. 10A and 10B are isometric and sectional views respectively of an adjustment stud of the crimp press of FIG. 6;

FIGS. 11A and 11B are isometric and sectional views respectively of an adjustment nut of the crimp press of FIG. 6;

FIG. 13 is an isometric view of an adjustment block of the crimp press of FIG. 6;

FIG. 14A is an isometric view of a cylinder die plate for the crimp press of FIG. 6, and FIGS. 14B and 14C are isometric and elevational views, respectively, of a track die plate for use with the cylinder die plate of FIG. 14A;

FIGS. 15A, 15B, and 15C are views similar to FIGS. 14A, 14B, and 14C, respectively, of an alternative set of die plates for use in the crimp press of FIG. 6;

FIGS. 16A, 16B, and 16C are views similar to FIGS. 14A, 14B, and 14C, respectively, of another alternative set of die plates for use in the crimp press of FIG. 6;

FIG. 17A is an elevational view of another crimp press according to the present invention;

FIG. 17B is a partially cut away elevational view of the crimp press of FIG. 17A taken generally along the lines B-B of FIG. 17A; and

FIG. 18 is an elevational view of yet another crimp press according to the present invention.

### DETAILED DESCRIPTION OF THE DRAWINGS

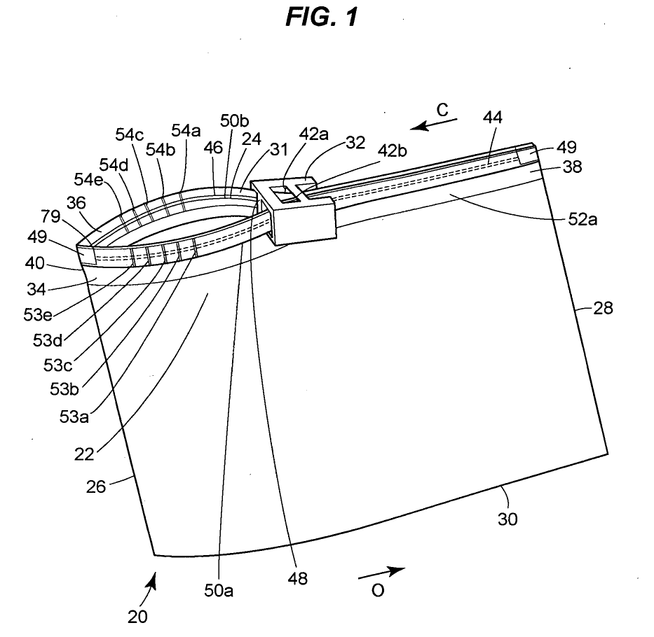

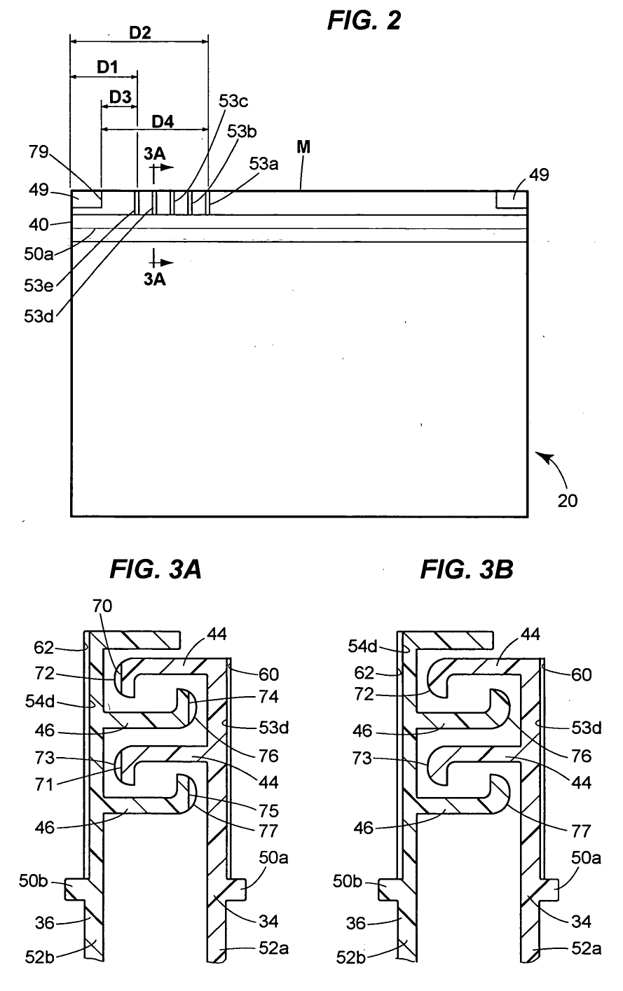

Referring to FIGS. 1-3, a pouch 20 includes opposed walls 22, 24 sealed along edges 26 and 28. The walls 22, 24 are integral with one another at a bottom edge 30, or alternatively, are sealed to one another at such location. The walls 22, 24 define a mouth 31 therebetween. Movement of a slider 32 along opposed closure profile strips 34, 36 in the direction of an arrow C from a first end 38 to a second end 40 closes the mouth 31 of the pouch. In this regard, the slider 32 includes opposed wall portions 42a, 42b that pinch and thereby interlock profiles 44, 46 of the strips 34, 36 together as is well known in the art. Movement of the slider 32 in the direction of an arrow O opens the pouch. In this regard, a separator finger 48 of the slider 32 separates the profiles 44, 46 during movement in the direction of the arrow O.

Suitable end stops 49 are provided at the ends 38, 40 of the pouch 20, wherein the end stops 49 prevent the slider 32 from sliding off the ends 38, 40 of the pouch 20. The end stops 49 may be regions of the strips 34, 36 that are heat sealed together and deformed. Referring also to FIG. 3A, the strips 34, 36 may include rails 50a, 50b that guide movement of the slider 32. The strips 34, 36 may further include flange portions 52a, 52b that are sealed to the pouch walls 22, 24, respectively.

FIG. 1 shows a plurality of indentations 53a-53e disposed in the strip 34 adjacent the second end 40 of the pouch 20. It should be noted that any suitable number of indentations may be provided adjacent the second end 40 to provide an audible and/or tactile indication of pouch closure when a user slides the slider 32 over the indentations 53. In pouches lacking the indentations 53, a user may have difficulty readily determining whether the slider 32 is moving in a direction to close the pouch 20 or a direction to open the pouch 20. With such conventional pouches, the user might have to visually inspect whether such pouch is closing or has been closed. By positioning the indentations 53a-53e adjacent only the second end 40, a user is provided with a tactile indication of pouch closure as the slider 32 passes over the indentations 53 en route to the second end 40. This can be highly advantageous for persons who are blind or have other visual impairments and cannot visually inspect the pouch 20 to determine whether the pouch is closed. In addition, the indentations 53 are also advantageous even for visually able persons considering such persons need not even look at the pouch 20 to determine whether the pouch 20 is closing or has been closed. The strip 36 may also include indentations 54a-54e similar or identical to the indentations 53a-53e and that function in like manner thereto.

Referring to FIG. 3A, the indentations 53 may be formed in an exterior surface 60 of the strip 34. The indentations 54 may likewise be formed in an exterior surface 62 of the strip 36. FIG. 3A shows indentations 70, 71 formed in surfaces 72, 73 of the profiles 44 and indentations 74, 75 formed in surfaces 76, 77 of the profiles 46. Movement of the slider 32 toward the second end 40 causes the opposed wall portions 42a, 42b to exert pressure on the strips 34 and 36. The pressure varies as the slider 32 moves over the indentations 53, 54, 70, and/or 71 to provide an indication of closure. FIG. 3B shows an alternative embodiment lacking the indentations 70, 71, 74, 75 shown in FIG. 3A.

Preferably, although not necessarily, the indentations 53 or 54 are disposed between a midpoint M of the bag and the closing end 40. The indentations 53 or 54 are preferably spaced a minimum distance D1 from the end 40 and a maximum distance D2 from the end 40, D2 being preferably less than M. Spacing the indentations 53 or 54 from the end 40 allows the user to know whether the slider 32 is moving in the closing direction prior to the slider 32 actually reaching and contacting the end 40.

D1 could optionally range anywhere between about 0.75 inches (about 1.9 cm) and about 3 inches (about 7.6 cm), depending upon the size of the bag. More preferably, D1 could range between about 1 inch (about 2.5 cm) and about 2 inches (about 5.1 cm), and even more preferably between about 1 inch (about 2.5 cm) and about 1.5 inches (about 3.8 cm). D2 could optionally range anywhere between about 1 inch to about 3.5 inches. Preferably, D2 measures about 1.8 inches (about 4.6 cm). It should be noted that in bags having end stops such as the end stops 49, the indentations 53 or 54 could measure a minimum distance D3 measured from an inner periphery or boundary 79 of the end stop 49. In addition, the indentations 53 or 54 could measure a maximum distance D4 from the boundary 79. D3 could range between about 0.3 inches (about 0.8 cm) to about 2 inches (about 5.1 cm), and D4 could range between about 1.5 inches (about 3.8 cm) to about 3.5 inches (8.9 cm).

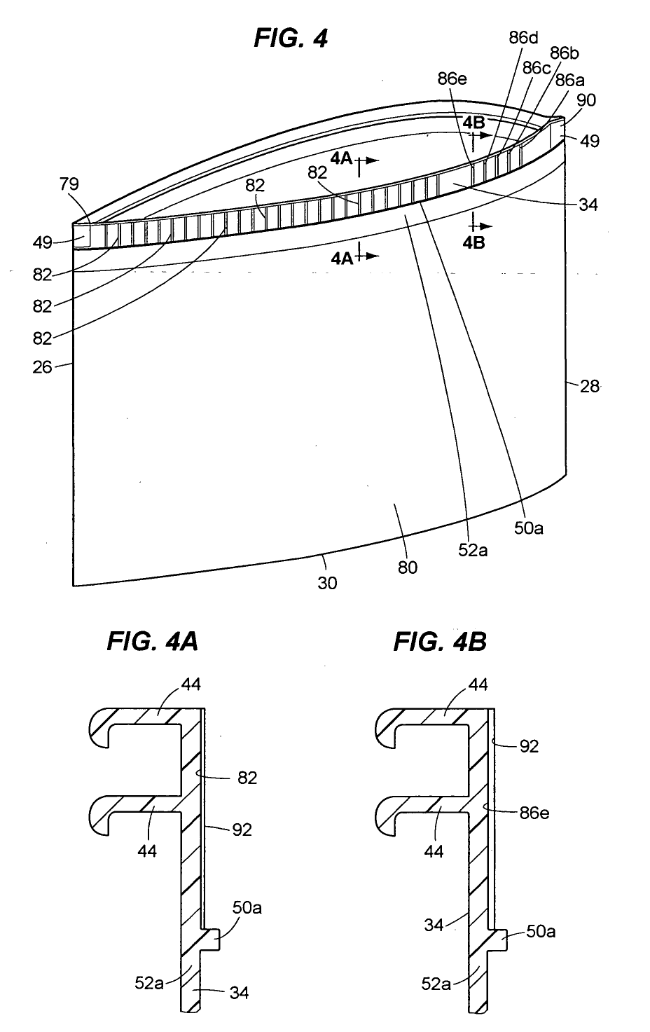

FIG. 4 illustrates a pouch 80 having a series of indentations 82 disposed generally along the length of the strip 34 and/or 36 as well as a plurality of indentations 86a-86e disposed only adjacent one end 90 of the pouch 80. The indentations 86 may have a characteristic different than the indentations 82 to provide a user with a tactile or audible indication of closure. For example, the indentation 86e shown in FIG. 4B has a depth greater than the indentation 82 shown in FIG. 4A as measured from a surface 92 of the strip 34. It should also be noted that the indentations 86 may be spaced apart from one another differently than the indentations 82 to provide an indication of pouch closure when the slider 32 passes over the indentations 86.

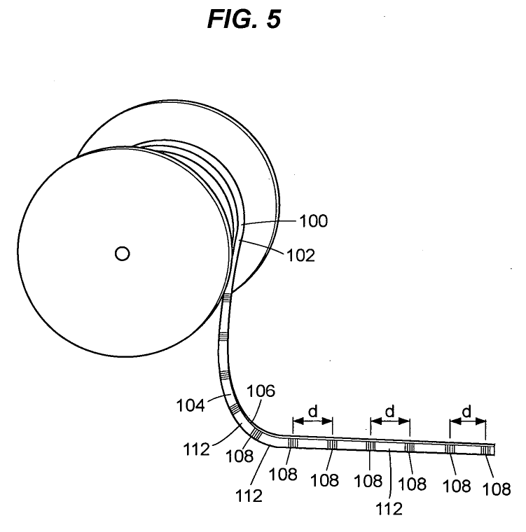

Referring to FIG. 5, a roll 100 of closure material 102 includes opposed closure strips 104, 106 similar or identical to the strips 34, 36 of the foregoing embodiments. One or both of the strips 104, 106 includes portions 108 having indentations similar or identical to the indentations 53, 54, 70, 71, 74, or 75. The centerlines of the portions 108 are spaced apart by a distance d equal to the width of the bag 20 as measured between the ends 38, 40. The closure material 102 is joined to bag wall material, and the closure material 102 and bag wall material are severed to form a bag such as the bag 20 having the one of the portions 108 adjacent the closing end 40. The distance d may be any suitable distance such as at least about 3 inches (about 7.6 cm). Alternatively, the distance d could be up to about 20 inches (about 50.8 cm) or more, depending upon the desired bag size. Regions 112 are disposed between the portions 108. The regions 112 could optionally include further indentations such as the indentations 82 having one or more characteristics different than the characteristics of the indentations of the segments 108.

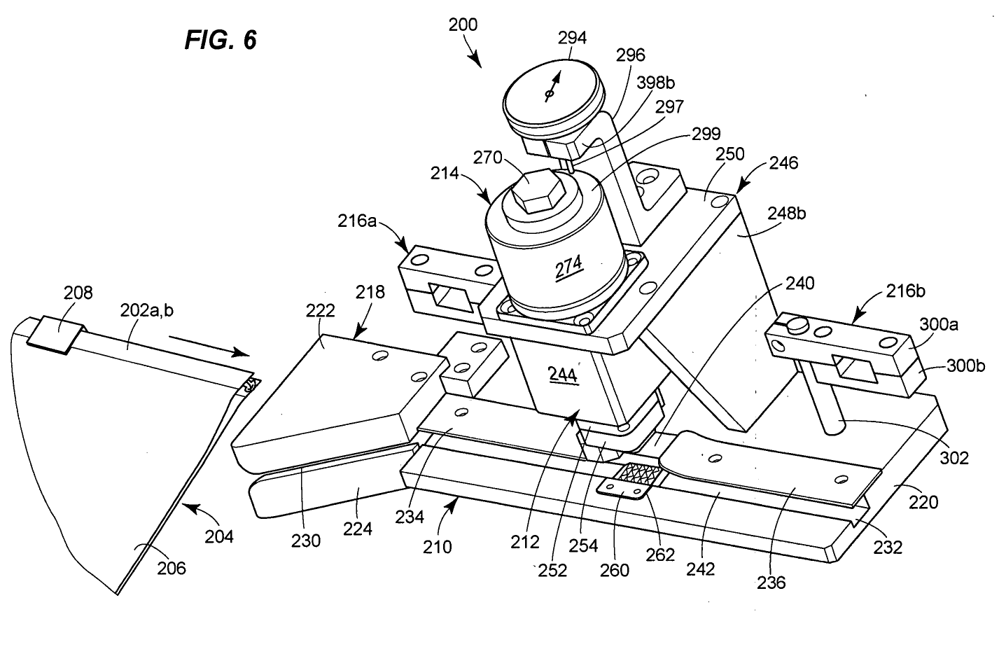

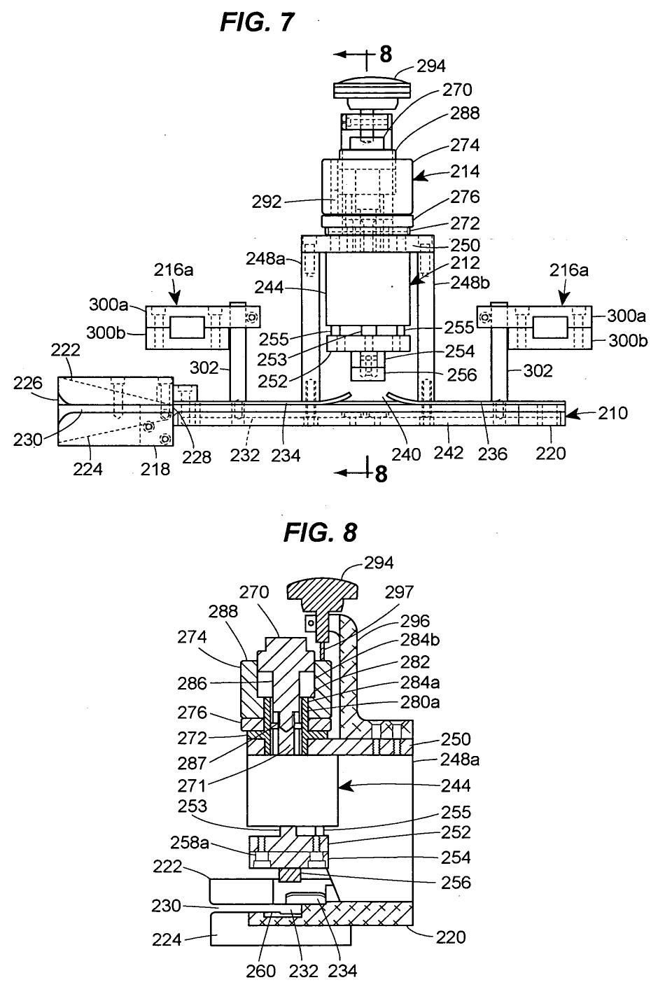

Referring now to FIGS. 6-16, a crimp press 200 is used to form a set of indentations, such as the indentations 53a-53e described above, in a pair of interlocked closure strips 202a, 202b in a pouch production line (not shown) having an intermittent motion feed system. The closure strips 202a, 202b are joined to an elongate folded web 204 of thermoplastic material that is thereafter segmented and separated into individual pouches (not shown) at a downstream position in the line. At this point in the production process, sliders 208 (one of which is visible in FIG. 6) are installed at spaced locations on the closure strips 202a, 202b. In addition, end stops (not shown) have been formed at spaced locations of the closure strips 202a, 202b. If desired, the crimp press may be positioned relative to other components of the production line such that sliders are thereafter installed on the closure strips 202a, 202b and/or end stops are thereafter formed. The crimp press 200 includes a guide sub-system 210 for guiding the web 204 through the press, an impact press sub-system 212 for forming the indentations in the closure strips 202a, 202b, a stroke adjustment sub-system 214 for controlling the stroke of the press sub-system, and mounting structures 216a, 216b for mounting the press to a support structure (not shown).

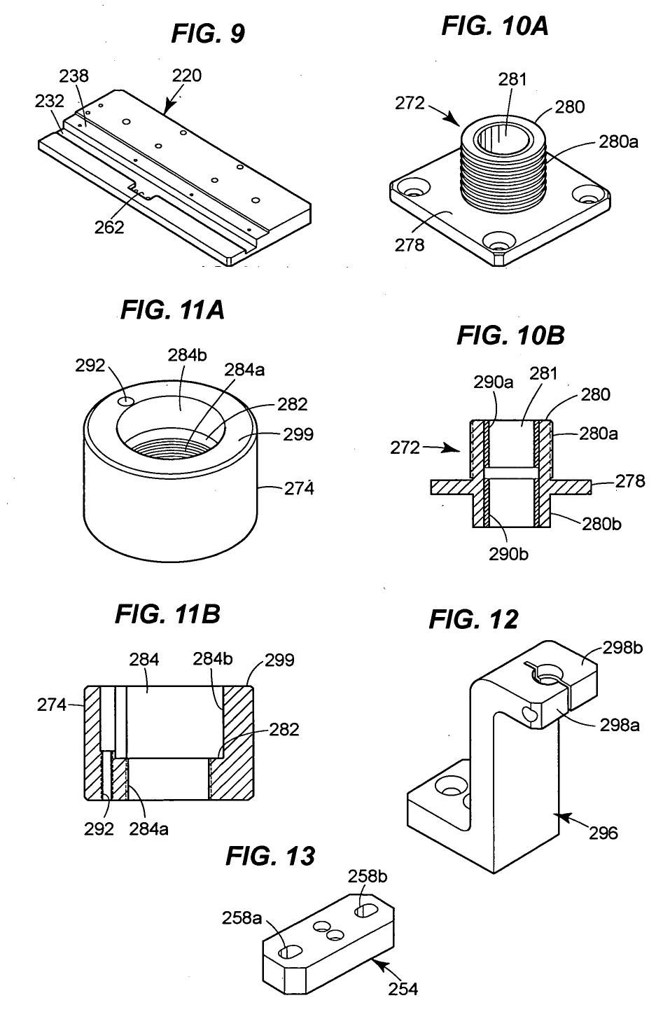

The guide sub-system 210 includes an inlet funnel 218 and a track plate 220 (best seen in FIG. 9). The inlet funnel 218 includes an upper portion 222 and a lower portion 224 that converge from an inlet 226 toward an outlet 228. A slit 230 extending from the inlet 226 to the outlet 228 between the upper and lower funnel portions allows the web 204 to extend out of the funnel 218 while the interlocked closure strips 202a, 202b and slider 208 are inside the funnel. The funnel 218 is located adjacent to the track plate 220, and the funnel outlet 228 opens into a groove or guide track 232 having a recessed floor 233 and extending along the track plate. Together, the inlet funnel 218 and the guide track 232 define a pathway along which the interlocked closure strips 202a, 202b and sliders 208 may pass. An entry hold-down bar 234 and an exit hold-down bar 236 prevent the closure strips 202a, 202b and slider 208 from shifting laterally out of the guide track 232 as the closure strips and slider pass therethrough. Preferably, the hold down bars 234, 236 allow the slider 208 to pass freely along the guide track 232 without substantial compression or increased frictional resistance. The hold down bars 234, 236 are secured with fasteners (not shown) to the track plate 220 in a recessed step 238 (FIG. 9) extending adjacent to the guide track 232 and partially cover and enclose the guide track. The step 238 allows the hold-down bars 234, 236 to lie substantially flush with the top of the track plate 220. The entry hold-down bar 234 is located adjacent to the inlet funnel 218, and the exit hold-down bar 236 is spaced from the entry hold-down bar thereby defining a die stomp opening 240 therebetween. A longitudinal opening 242 where the hold down bars 234, 236 do not cover the guide track 220 extends along the guide track from the slit 230 in the inlet funnel 218 to allow the web 204 to extend therethrough when the closure strips 202a, 202b are in the guide track 232. However, the opening 242 is preferably not large enough to allow the slider to pass therethrough. The ends of the hold-down bars 234, 236 adjacent to the die stomp opening 240 are curved slightly upwardly to accommodate an upward motion of the slider 208 as the slider passes the die stomp opening as discussed below.

The impact press sub-system 212 includes a cylinder 244 suspended over the die stomp opening 240 by a support housing 246. The cylinder 244 may be activated using any convenient technology, such as air pressure, hydraulics, cams, or computer controlled servo motors. Preferably, the cylinder 244 is a compact air cylinder such as the EF1 double acting/double rod cylinder available from Bimba Manufacturing Co. of Monee, Ill., but other suitable actuators could also be used. The support housing 246 includes side plates 248a and 248b extending upwardly from the track plate 220 adjacent to the step 238 and a top plate 250 spanning across the side plates. The cylinder 244 is carried by the top plate 250 between the side plates 248a, 248b over the die stomp opening 240 such that a tooling plate 252, which is carried by a lower piston rod 253 extending downwardly from the cylinder and reciprocates up and down with a piston (not shown) in the cylinder during a piston stroke, can urge a die adjustment block 254 and/or a cylinder die plate 256 into the guide track 232 when the piston is extended. Guide rods 255 extending from the cylinder 244 and attached to the tooling plate 252 help guide the tooling plate during a piston stroke. The die adjustment block 254 is adjustably secured to the tooling plate 252 by fasteners (not shown) through a pair of elongate slots 258a, 258b, and the cylinder die plate 256 is secured to the tooling plate by fasteners (not shown). The elongate slots 258a, 258b, allow the adjustment block and the cylinder die plate 256 to be shifted and secured at different positions over the guide track 232. Specifically, the elongate slots 258a, 258b extend laterally with respect to the guide track 232 so that the cylinder die plate 256 may be adjusted laterally across the guide track. A track die plate 260 is secured to the track plate 220 in the guide track 232 at the die stomp opening 240 opposite the cylinder die plate 256. A portion of the track die plate 260 fits within a recess 262 adjacent to the guide track 232 and opposite the step 238, which provides for consistent placement of the track die plate within the guide track. The track die plate 260 is secured to the track plate 220 within the recess 262 with fasteners (not shown) such that the track die plate may be readily removed and replaced. The track die plate 260 has a beveled or ramped leading edge 264 facing toward the inlet funnel 218 to guide the closure strips 202a, 202b up and over an elevated face 269 of the track die plate 260. The die face 269 is elevated above the floor 233 of the guide track 232 in order to eliminate or minimize any vertical shifting of the closure strips 202a, 202b during a piston stroke, which could cause quality control problems or operational problems due to bunching or jamming of the closure strips. Preferably, the die face 269 is elevated above the guide track floor 233 a distance equal to any space between the floor 233 and the lower of the closure strips 202a or 202b caused by the thickness of the slider in order to eliminate or minimize any space between the die face and the closure strips when the slider is adjacent to the track die plate 260. As should be evident, one could instead provide more or less elevation at this location, as desirable or necessary. The upturned ends of the hold-down bars 234, 236 allow the slider to be smoothly shifted sequentially upward and then back downward when passing over the ramped leading edge 264 and the elevated die face 269 of the track die plate 260.

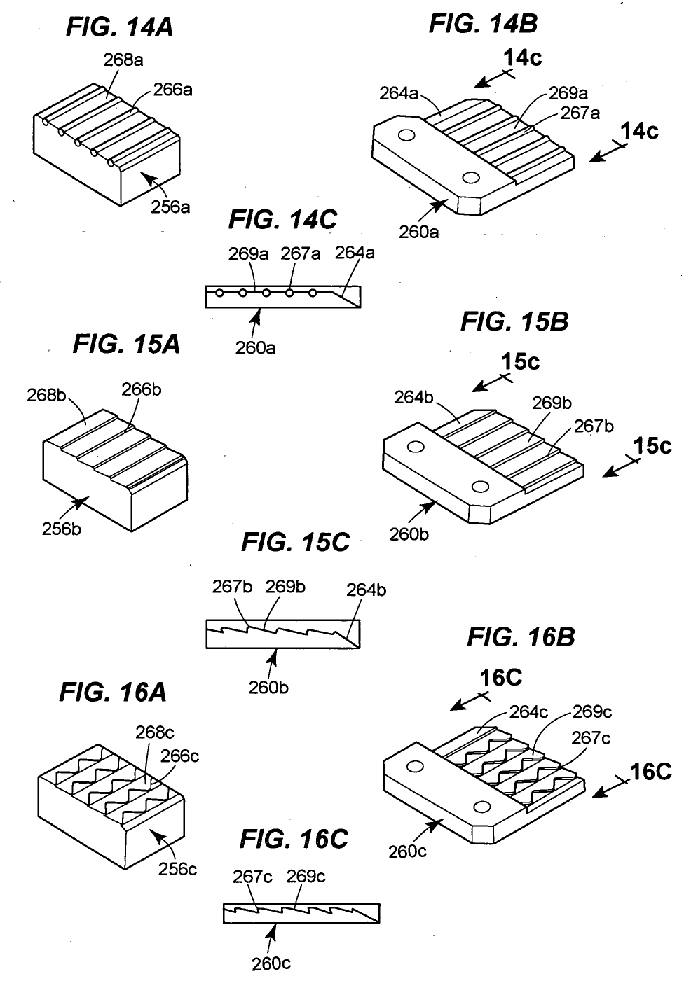

A set of die plates including a cylinder die plate 256a and a track die plate 260a shown in FIGS. 14A-14C are particular embodiments of the die plates 256 and 260 previously described used with the crimp press 200 to form the indentations 53a-56e into the closure strips 202a, 202b. The cylinder die plate 256a includes a plurality of cylindrical ridges 266a protruding above a face 268a of the die plate and a ramped leading edge 264a. Preferably, the cylinder die plate includes five ridges 266a, but any desired number of ridges could be used. The track die plate 260a likewise includes a matching plurality of cylindrical ridges 267a protruding above a face 269a. Preferably the track die ridges 267a are aligned opposing the cylinder die ridges 266a when the plates are secured in place to the track plate 220 and adjustment block 254. In this manner, when the cylinder die plate 256a is urged toward the track die plate 260a by the cylinder 244, opposing ridges 266a compress the closure strips therebetween to form the indentations 53a-53e. Alternatively, the ridges 266a, 267a may be offset from each other, if desired. Another set of die plates including a cylinder die plate 256b and a track die plate 260b shown in FIGS. 15A-15C are similar to the die plates 256a, 260a and used to form an alternative shape of the indentations. The die plates 256b, 260b include beveled ridges 266b, 267b in the faces 268b, 269b, respectively, thereof, and the track die plate includes a ramped leading edge 264b. Yet another set of die plates including a cylinder die plate 256c and a track die plate 260c shown in FIGS. 16A-16C are similar die plates 256b, 260b and used to form an yet another alternative shape of the indentations. The die plates 256c, 260c include beveled ridges 266c, 267c that have a zigzag shape in the faces 2268c, 269c, respectively, thereof, and the track die plate includes a ramped leading edge 264c. Any one of the sets of die plates shown in FIGS. 14-16 may be substituted for another set of the die plates and used in the crimp press 200 depending on what form of indentations in the closure strips 202a, 202b is desired. Alternatively, other die plates similar to those shown in FIGS. 14-16 with other desired ridge shapes or other embossing surfaces in the faces thereof could be used to form practically any desired shape of indentation in the closure strips 202a, 202b.

The adjustment sub-system 214 includes a plunger, preferably a stop bolt 270, secured to an upper piston rod 271 extending upwardly from the cylinder 244, an adjustment stud 272 surrounding the stop bolt 270, an adjustment nut 274 threaded onto the outer periphery of the adjustment stud, and a jam nut 276 threaded around the adjustment stud below the adjustment nut. The adjustment stud 272 (best seen in FIGS. 10A and 10B) includes a mounting flange 278 located between an externally threaded upper portion 280a and a lower portion 280b of a cylindrical boss 280. The flange 278 of the adjustment stud is secured to the top plate 250 with the lower portion 280b of the boss 280 extending through a hole in the top plate to the cylinder 244. The adjustment nut 274 (best seen in FIGS. 11A and 11B) includes a central through bore 284 having a stepped inner peripheral annular shoulder 282 located between a threaded lower bore portion 284a and a smooth upper bore portion 284b. The threaded lower bore portion 284a of the adjustment nut engages the externally threaded upper boss portion 280a of the adjustment stud 272. A shank 286 of the stop bolt 270 extends through the central bore 284 of the adjustment nut 274 and the central through bore 281 of the boss 280 and is threadedly secured into a sleeve 287 at an upper end of the upper piston rod 271 such that the bolt follows the piston and piston rods 271, 253 during a piston stroke. A head 288 of the bolt 270 extends over the boss 280 and annular shoulder 282 of the adjustment nut 274 and is spaced above the boss and shoulder when the piston in the cylinder 244 is retracted. Preferably, the adjustment nut 274 is long enough such that the head 288 of the bolt 270 does not completely clear the upper bore portion 284b when the piston in the cylinder 244 is fully retracted in order to minimize any potential pinch points for an operator. When the piston in the cylinder 244 is extended, the bolt head 288 slides within the smooth upper bore section 284b of the adjustment nut 274 toward the shoulder 282. The stop bolt 270 ends the piston extension stroke when the bolt head 288 engages the shoulder 282 of the adjustment nut 274 and/or the upper boss portion 280a of the adjustment stud 272. The central bore of the boss 280 is fitted with upper and lower bushings 290a, 290b to provide proper fit for the adjustment bolt shank 286 within the boss central bore 381 and to provide replaceable wear surfaces. If desirable or necessary, a single bushing could instead be used or the bushings may be omitted, if desired, and/or other fitting and/or wear surfaces could alternatively or additionally be used. The adjustment nut 274 may be shifted upwardly or downwardly along the path of the piston stroke by advancing and retracting the nut 274 along the outer threads of the boss 280. The adjustment nut 274 is screwed upwardly along the boss 280 to decrease the length of the cylinder stroke and downwardly along the boss to increase the length of the cylinder stroke. The jam nut 276 locks the adjustment nut 274 at a desired adjustment location along the boss 280 by screwing or jamming the jam nut 276 against the adjustment nut 274 at the desired adjustment location. Of course, other locking mechanisms could be used such as clamping devices or interlocking mechanisms. A lock screw (not shown) may be extended and retracted through a threaded lock screw bore 292 extending through the adjustment nut 274 to engage the jam nut 276 and thereby provide an additional locking mechanism for the adjustment nut. An adjustment measurement and indication device such as a dial indicator 294 is carried by a bracket 296 connected to the top plate 250. The dial indicator 294 includes a spring loaded follower pin 297 that remains in contact with an upper end 299 of the adjustment nut 274. The bracket 296 includes a pair of opposing arms 298a, 298b that fit around the dial indicator 294 and may be clamped together to secure the dial indicator in a desired position over the adjustment nut 274. The end 299 of the adjustment nut 274 urges the pin 297 upwardly or downwardly when the nut 274 is advanced or retracted upwardly or downwardly along the adjustment stud 272, thereby causing the dial indicator 294 to indicate the stroke of the piston in the cylinder 244. Alternative adjustment mechanisms, such as an adjustable plunger bolt, could also be used, and other adjustment mechanisms could be adapted for use with different types of actuators. For example, a computer could be used to control the extension of a piston and cylinder actuated by a servo motor, or hydraulic controls could be used with a hydraulic cylinder. In addition, an alternative adjustment indicator device could be used, such as an electro-optical measurement device or a linear encoder.

The mounting structures 216a, 216b are located on opposite sides of the support housing 246. Each mounting mechanism includes opposing clamps 300a, 300b carried by a stud 302 secured to the track plate 220. The mounting clamps 300a, 300b may be clamped to the support structure to maintain the crimp press 200 in a desired position along the pouch production line. Any other type of mounting mechanism that can maintain the crimp press in a desired location along the pouch production line could be used alternatively or additionally.

In operation, the web 204 is fed into the inlet 226 of the inlet funnel 218 such that the web 204 extends through the slit 230 and opening 242 and the interlocked closure strips 202a, 202b and the slider 208 pass through the inlet funnel, out the outlet 228, and along the guide track 232. Prior to entering the inlet funnel 218, the slider 208 may be selectively pre-positioned along the closure strips 202a, 202b by a paddle (not shown) upstream of the crimp press 200. The web 204 may be fed through the crimp press 200 by any suitable means (not shown) during a series of intermittent motion cycles wherein each cycle includes a line advance sequence and a die stomp sequence during which the web 204 is stopped. During the line advance sequence, the web 204 is advanced through the guide track 232 in the crimp press 200 a predetermined length, which is preferably the width of a finished pouch. The slider is maintained in the pre-selected position relative to the closure strips 202a, 202b by the sliding frictional forces between the slider and the closure strips because the hold down bars 234, 236 do not substantially restrict the slider from passing through the guide track 232. The web is then stopped when the slider 208 is directly adjacent to the track die plate 260 opposite the ramped leading edge 264. Next, during the die stomp sequence, the cylinder 244 is activated causing the cylinder die plate 256 to travel toward the track die plate 260 a defined stroke distance controlled by the location of the adjustment nut 274 along the adjustment stud boss 280. At the bottom of the cylinder stroke, the cylinder die plate 256 impacts or squeezes the interlocked closures strips 202a, 202b against the track die plate 260 and the ridges 266, 267 thereby form indentations such as 53a-53e along the outer portions of the interlocked closure strips. The cylinder 244 is then retracted, and the advance and die stomp sequences may be repeated.

The crimp press 200 can also be used to form the indentation portions 108 in the roll 100 of closure material 102 shown in FIG. 5 in a similar manner. In this case, there would be no web extending through the slit 230 or opening 242, and any advancement system would have to be adapted to handle the closure material without having a web to grip.

The degree of crimp deformation and size of the indentations 53a-53e of the closure strips 202a, 202b may be controlled and adjusted with the stroke adjustment system 214 by increasing or decreasing the piston stroke. Preferably, the piston stroke is adjusted such that the die plates 256, 260 form only the indentations 53 on the exterior surface of the strips 202a, 202b, and minimize the formation of any indentations on the interior surface of the closure profiles, such as the indentations 70, 71, 74, 75 of FIG. 3A. For example, if the die plates 256, 260 are not stroked close enough together during the die stomp sequence the closure strips 202a, 202b may be under-crimped and the indentations 53 not formed. In that event, the adjustment nut 274 may be threaded downwardly along the adjustment stud boss 280 to increase the stroke of the piston in the cylinder 244 and bring the die plates 56, 60 closer together during the stroke. Conversely, if the die plates 256, 260 come too close together during the die stomp sequence, the closure strips 202a, 202b may be over-crimped and damaged. In this event, the adjustment nut 274 may be threaded upwardly along the boss 280 to decrease the cylinder stroke and keep the die plates 56, 60 farther apart during the stroke. If the indentations 70, 71, 74, 75 are also desired, the adjustment mechanism 214 may be set at an intermediate position such that the stroke causes the die plates 56, 60 to come together enough to impart both the external indentations 53 and the internal indentations 70, 71, 74, 75 are formed in the interlocked closure strips 202a, 202b but not so much as to damage the closure strips.

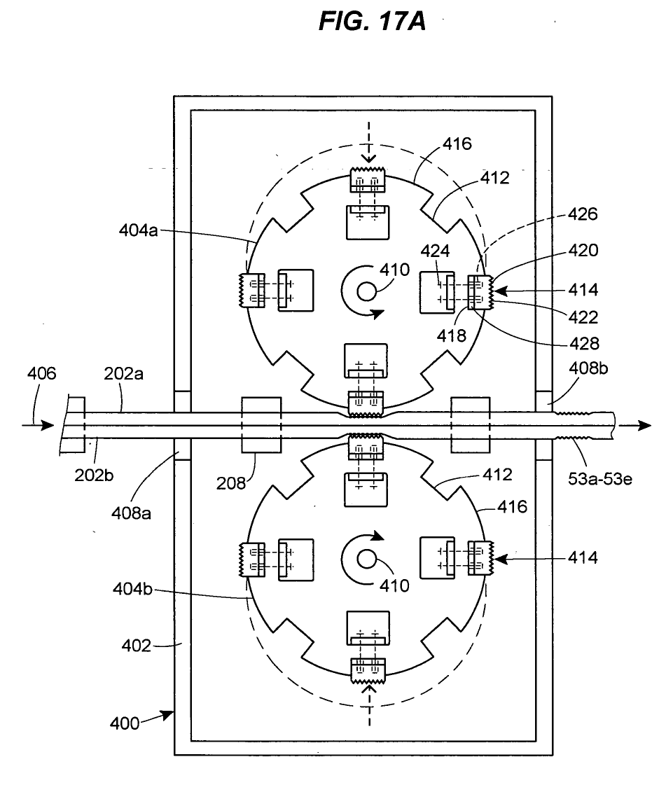

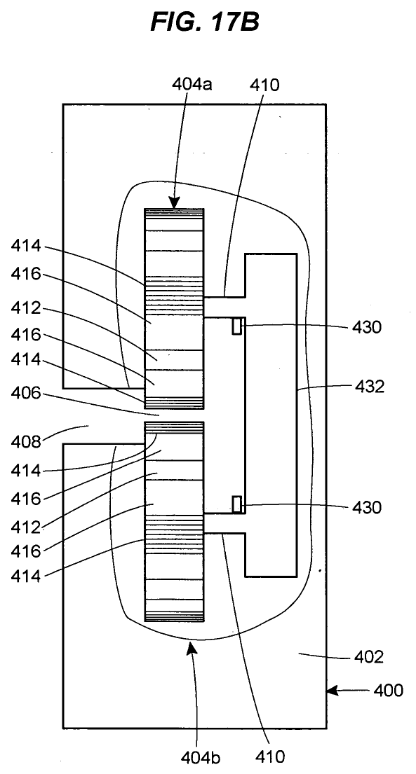

Another crimp press 400, shown in FIGS. 17A and 17B, is used to form a set of the indentations 53a-53e at regularly spaced locations along the closure strips 202a, 202b on a pouch production line (not shown) having a continuous motion feed system. The crimp press 400 includes a housing 402 and two opposing rotary press wheels 404a, 404b on opposite sides of a feed path 406 along which the closure strips 202a, 202b extend. Openings 408a, 408b through opposite sides of the housing are aligned with the feed path 406 to permit the closure strips 202a, 202b, any bag web attached thereto, and sliders 208 to pass through the housing and between the wheels 404a, 404b.

Each press wheel 404 is rotationally carried by a shaft 410 extending from the housing 402 and includes circumferentially spaced slider cutouts 412 and die blocks 414 in the peripheral surface 416 of the wheel. Each die block 414 and cutout 412 is regularly spaced circumferentially around the wheel 404 from the adjacent die block or cutout a circumferential distance equal to one finished bag length. Each cutout 412 is sized to receive at least a portion of one of the sliders 208 therein so that the slider is not damaged when passing between the wheels 404. Each die block 414 is secured within a recessed portion 418 of the wheel periphery 416 such that a face portion 420 of the die block having raised ridges 422 protrudes radially beyond the wheel periphery for forming the indentations 53 in the closure strips 202. The die block 414 is secured to the wheel using fasteners 424 such as bolts extending radially through a portion of the wheel into a threaded bore 426 in the die block 414, thereby allowing the die block 414 to be easily removed and replaced. Spacers 428 are optionally disposed between the die block 414 and a base surface of the recessed portion 418 so as to obtain a desired projection of the face portion 420 beyond the wheel periphery 416.

Each press wheel 404a, 404b shifts from a set-up position vertically spaced from the feed line 406 for ease of initial set up (partly shown in dashed lines in FIG. 17A) to a use position substantially tangentially coincident with the feed line. Adjustable mechanical stops 430 are set in appropriate positions to stop the wheels 404 in the use position spaced apart from each other a desired distance. Alternatively, only one of the wheels 404a, 404b may shift while the other wheel remains fixed with respect to the feed line 406. Although both wheels 404a, 404b could remain fixed with respect to the feed line 406, having at least one of the wheels shiftable toward and away from the feed line 406 is preferred in order to provide a measure of adjustability to the crimp press 400 and for ease of set up. In the use position, the peripheral surface 416 of each wheel 404 preferably presses slightly against the closure strips 202 therebetween with a force that does not damage the closure strips. In this situation, the press wheels 404 could help pull the closure strips 202 through the press without damaging the closure strips, if desired. Preferably, however, the closure strips 202 are advanced continuously along the feed line 406 by other mechanisms known in the art, such as a draw roll (not shown), and the tangential speed of the outer periphery 416 of the press wheels 404 is matched to the speed of the closure strips so that the press wheels neither pull nor resist the passing closure strips. Preferably, the wheels 404a, 404b are spaced from each other a distance sufficient to prevent opposing die blocks 414 from over crimping or deforming the closure strips 202 during operation.

A drive mechanism such as a drive unit 432 (seen in FIG. 17B) rotates the shafts 410 and press wheels 404 in synchronized rotational motion during use such that the press wheel 404a rotates counter clockwise and the press wheel 404b rotates clockwise (all as depicted in FIG. 17A). The synchronized rotation of the press wheels 404a, 404b is such that two opposing die blocks 414 on the wheels simultaneously converge against the closure strips 202 to form the indentations 53, and two opposing slider cutouts 412 converge around a slider 208 as the slider passes between the press wheels. Preferably, the drive unit 432 includes a single servomotor (not shown) that drives both shafts 410 through appropriate gearing to provide the synchronized rotation of the press wheels 404. Other drive mechanisms could be used to rotate the press wheels in synchronized motion such as, e.g., belts or two synchronized servomotors with each motor connected to one of the shafts 410. In addition, the drive unit 432 is preferably synchronized to the operation of other bag forming apparatus of a bag production line, of which the press 400 is a part.

In operation, the interlocked closure strips 202a, 202b are advanced between the press wheels 404 in a continuous motion. Each slider is selectively pre-positioned along the closure strips prior to reaching the press wheels 404 using known positioning apparatus (not shown). The press wheels 404 rotate such that each slider passes between the wheels in converged slider cutouts 412, and converging die blocks 414 form the indentations 53 in the closure strips between adjacent sliders 208.

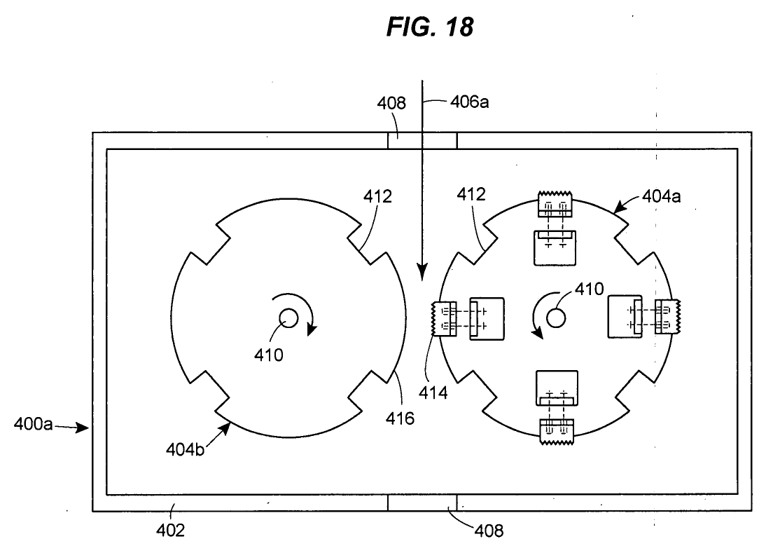

Another crimp press 400a, shown in FIG. 18, is similar to the crimp press 400 except that the press wheel 404c does not include any die blocks 414. Rather, the press wheels 404a, 404c are synchronized to move such that the die blocks 414 on the press wheel 404a converge toward the substantially cylindrical outer periphery 416 of the press wheel 404c, and opposing slider cutouts 412 in both press wheels converge together around a slider (not shown). The die press 400a is used to form the indentations 53 in only one of the interlocked closure strips 202a or 202b at regularly spaced locations along the closure strips as described above. The die press 400a may also be used to form the indentations 53 in a single closure strip 202a or 202b that is not interlocked with an opposing strip by preferably passing the closure element adjacent to the press wheel 404c and the exterior surface of the strip 202a or 202b adjacent to the press wheel 404a.

In addition to the foregoing difference, the closure strip(s) traverse a vertical feed path 406a through the press 400a, as opposed to the horizontal path 406 of movement through the press 400. In all other respects, the press 400a has similar or identical structure as, and operates in similar or identical fashion to, the press 400 described above.

### INDUSTRIAL APPLICABILITY

The above-described crimping apparatus may be used to form the above described indentation sets in the closure strips of the above-described bags.

Numerous modifications will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A device for forming an indentation in a closure strip, wherein the device comprises:
a funnel adapted to receive the closure strip;
a partially enclosed track extending from the inlet funnel and adapted to receive the closure strip therein;
an indentation die located adjacent to the track and shiftable toward the track; and
an actuator connected to the die, wherein the actuator urges the die toward the track for forming the indentation in the closure strip.

2. The device of claim 1 and further comprising an adjustment mechanism in communication with the actuator, wherein the adjustment mechanism has a first setting, which causes the actuator to urge the die to a first position spaced adjacent to the track, and a second setting, which causes the actuator to urge the die to a second position more closely spaced adjacent to the track than the first position.

3. The device of claim 2 wherein the funnel and track are further adapted to receive and guide a slider connected to the closure strip.

4. The device of claim 3 and further comprising a slit extending along the funnel and track for receiving therethrough a web extending from the closure strip.

5. The device of claim 2 and the actuator further comprising a reciprocating drive member, wherein the die is carried by the drive member.

6. The device of claim 5 and the drive member further comprising a pneumatic cylinder.

7. The device of claim 5 wherein the adjustment mechanism includes a plunger that follows the drive member, and wherein the plunger ends an extension stroke of the drive member by engaging a stop surface.

8. The device of claim 7 wherein the stop surface is shiftable between the first setting and the second setting.

9. The device of claim 2 and further comprising a second die spaced opposite the first die.

10. An apparatus for forming indentations in a pair of interlocked closure strips carrying a slider comprising:
an inlet funnel and a guide track extending from the inlet funnel, wherein the interlocked closure strips and the slider are slidably carried within the inlet funnel and the guide track;
an indentation die adjacent to the track and carried by an actuator;
wherein the actuator shifts the die between a first position spaced away from the track and a second position spaced nearer to the track to form the indentations in the interlocked closure strips.

11. The apparatus of claim 10 wherein the closure strips are compressed between the die and the track when the actuator shifts the die from the first position to the second position thereby forming an indentation on at least one of the closure strips.

12. The apparatus of claim 11, and further comprising a second die spaced opposite the first die, wherein the interlocked closure strips are compressed between the first and second dies when the actuator shifts the first die from the first position to the second position, thereby forming an indentation on each of the closure strips.

13. The apparatus of claim 12, and the actuator further comprising a pneumatic cylinder.

14. The apparatus of claim 13 and the actuator further comprising an adjustment mechanism in communication with the cylinder, wherein the adjustment mechanism has a first setting and a second setting, and wherein the second setting causes the second position of the die to be nearer to the track than does the first setting.

15. The apparatus of claim 14, and further comprising an opening extending along the inlet funnel and the guide track, wherein a pouch wall extending from at least one of the closure strips extends through the opening with the closure strip in the funnel and the track.

16. A method of forming an indentation in a closure strip carrying a slider and attached to a web, the method comprising the steps:
advancing the closure strip and slider a predefined length along a guide track adjacent to an impact die press;
stopping the closure strip adjacent to the die press; and
impacting the stopped closure strip with the die press within the guide track.

17. A device for forming indentations in an elongate closure strip, comprising:
a first rotatable die wheel having an outer periphery and a second rotatable die wheel having an outer periphery, wherein the first die wheel is spaced opposite the second die wheel a distance sufficient to allow the closure strip to pass between opposing portions of the peripheries thereof;
a raised die surface on the outer periphery of at least one of the die wheels; and
a drive mechanism for driving the die wheels in synchronized rotation such that the die surface is adapted to contact and form the indentations in the closure strip as the die wheels are rotated.

18. The device of claim 17, in combination with a length of closure strip.

19. The device of claim 18, wherein the closure strip includes first and second closure strip portions and a raised die surface is carried by each of the wheels and wherein the closure strip passes between the die wheels and the die surfaces periodically converge toward one another until the die surfaces are spaced a distance sufficient to form the indentations in the first and second closure strip portions.

20. The device of claim 17, and further comprising a recess in the outer periphery of each die wheel, whereby the recesses converge toward each other during rotation of the die wheels to form a space sufficient to accept a slider therebetween without compressing the slider.

21. The device of claim 18, wherein the closure strip traverses a horizontal path.

22. The device of claim 18, wherein the closure strip traverses a vertical path.
